(19) United States
(12) Patent Application Publication
(10) Pub. No.: US 2004/0134932 A1
(43) Pub. Date: Jul. 15, 2004

(54) Beverage dispenser

(76) Inventor: Vincent G. Lobdell, Pulaski, NY (US)

Correspondence Address: S. Peter Konzel, Esq., Simpson & Simpson, PLLC, 5555 Main Street, Williamsville, NY, 14221-5406, US

(21) Appl. No.: 10/693,507

(22) Filed: Oct. 22, 2003

Related U.S. Application Data
(60) Provisional application No. 60/420,651, filed on Oct. 23, 2002.

(51) Int. Cl. B67D 5/62

(52) U.S. Cl. 222/146.5; 222/146.6; 222/189.06

(57) ABSTRACT

The present invention broadly comprises a beverage dispenser for filtering and dispensing liquid beverages. The device includes an upper reservoir for receiving a liquid therein and is adapted to releasably secure a filter. The filter is arranged for communication with a lower reservoir for receiving the liquid beverage therein. The lower reservoir includes means for dispensing the filtered liquid and the filtered liquid therein may be heated or cooled by means of heating or cooling devices. The beverage dispenser is compact, portable and housed in an aesthetically appealing canister. Removal of the filter allows other beverages, such as lemonade, or tea, to be stored and dispensed on demand.

### CROSS REFERENCE TO RELATED APPLICATIONS

This application claims the benefit of U.S. Provisional Application No. 60/420,651, filed Oct. 23, 2002, which application is incorporated herein by reference.

### FIELD OF THE INVENTION

The present invention relates generally to an apparatus for dispensing beverages, and more particularly, to a beverage dispenser including a removable filter for filtering tap water, and optionally, chilling means, heater means, and CO₂ charging means for dispensing chilled, warmed, ambient and effervescent beverages. The beverage dispenser may be adapted for use with liquids other than water, for example, juices, teas and the like. The beverage dispenser of the present invention is compact, portable and aesthetically appealing.

### BACKGROUND OF THE INVENTION

Consumers are increasingly concerned with the quality of municipal, rural, and water well drinking water. In direct response to water quality issues, many consumers now demand alternative sources of safe drinking water. Consequently, the market for bottled spring and purified waters has increased significantly. In fact, the demand for specialty drinking waters has increased so dramatically that bottled water is now considered by many to be a basic commodity.

Bottled water is typically delivered to homes or businesses in portable 5-gallon containers designed to fit on stand-alone floor water cooler units, which are either rented from suppliers or purchased by the consumer. The stand-alone floor units are often large and typically require the consumer to buy bottled water from the supplier on a regular basis, e.g., weekly or monthly depending on the demand for bottled water, which can be costly. Costly bottled water can be substituted with low cost tap water and filtered to obtain water that is as clean, safe and even more pure than bottled drinking water.

Additionally, when they are filled to capacity, the 5-gallon containers used in association with most water coolers are heavy and often difficult to load onto the water cooler unit. Thus, there exists a need for a beverage dispenser unit that is relatively inexpensive and compact in size, such that it may be conveniently placed on a counter top.

To maintain bottled water at an ideal temperature for drinking, i.e., 38-43° F., a chilling mechanism that operates continuously and efficiently is required. Typically, refrigeration equipment for such water coolers includes conventional compressor-type mechanical refrigeration systems, which undesirably increase the overall cost complexity, size, and power consumption requirements of the water cooler. Alternatively, thermoelectric heat transfer modules provide a more compact and cost-effective means for chilling water within a cooler reservoir. However, the chilling capacity of thermoelectric modules is relatively small when compared to conventional compressor-type refrigeration systems, as a result thermoelectric modules require a longer chilling time or dependence on the formation of an “ice bank” for immediate chilling following a large withdrawal or several successive withdrawals of water from the water cooler. Thus, there also exists a need for a beverage dispenser unit that provides a chilling mechanism with the size and power consumption advantages of the thermoelectric modules, but which cools water more quickly and efficiently.

While the demand for bottled water has increased in residential and commercial applications, it has not replaced the convenience of tap water readily available from municipal, rural or private well systems. However, tap water from municipal sources often contains contaminates or chemical residues used in purification processes, e.g., chlorine, that are unhealthy and undesirable. Many private well systems contain suspended solids, organic chemicals and pathogenic bacteria. Thus, there exists a need for a beverage dispenser unit that also provides a high efficiency water purification system for the purification of common tap water from municipal, rural, or private well systems.

Water cooler units are often prominent fixtures in home and office environments. These units are typically comprised of a rectangular cooling unit that supports a cylindrical water bottle on top. While functional, these water cooler units are plain and lack any artistic design. Thus there exists a need for a beverage dispenser unit that is artistic in design.

Many variations in water cooler units are known in the art. Typically, these water cooler units are used to dispense cool water from a bottled source. For example, U.S. Pat. No. 6,003,318, entitled, “Thermoelectric Water Cooler,” describes a water cooler comprising a thermoelectric heat transfer module that chills water within a cooler reservoir. The water cooler includes a sensor that detects build-up of an ice bank within the cooler reservoir, and signals a controller to regulate the thermoelectric module to prevent excessive ice bank growth. This water cooler further includes an air filter for filtering air drawn by a fan, which circulates over a heat sink associated with the thermoelectric module. However, the Water cooler described in the '318 patent does not disclose a device for filtering water and is not suitable for purifying and chilling tap water. Hence, consumers are required to purchase bottled water, which can be costly.

U.S. Pat. No. 5,771,709, “Electric Counter Mounted Beverage Cooler and Dispenser,” describes a beverage cooler and dispenser. However, the '709 patent does not disclose means for filtering water.

U.S. Pat. No. 5,072,590, “Bottled Water Chilling System,” describes a chilling system for chilling or cooling a supply of water or the like to a selected low temperature suitable for drinking and other uses. The chilling system includes a thermoelectric heat transfer module having a cold side for extracting heat energy from water contained in a reservoir, and a hot side for transferring the extracted heat energy to a circulating heat transfer fluid. The invention described in the '590 patent does not include a filter for removing contaminates from water.

U.S. Pat. No. 4,913,713, “Versatile Countertop Cooler,” describes a countertop cooler for standard size water bottles. The '713 patent does not disclose means for filtering water.

U.S. Pat. No. 5,587,089, “Water Purification and Dispensing System,” describes a system for purifying water, washing a container with the purified water, and filling the container with the purified water. The system includes an apparatus comprising a water inlet system, a water purification system, a container washing system, a container filling system, an auxiliary function system, a mineralization system and an ozonating system. However, the apparatus is not adapted for chilling water or dispensing beverages.

U.S. Pat. No. 6,112,541, “Compact Cooling Apparatus” describes a water filtering and chilling device. However, while this device is capable of both filtering and chilling water, the device is not capable of filtering both chilled and non-chilled water. In addition, the device may only be used in connection with a faucet, or pressurized source of water. Finally, the '541 patent does not disclose whether the device may be adapted for use with beverages other than water.

Accordingly, there is a long felt need for a compact, aesthetically appealing beverage dispenser that is energy efficient and capable of filtering water and heating or cooling beverages.

### SUMMARY OF THE INVENTION

The present invention broadly comprises a device for filtering liquids. The device includes an upper reservoir for receiving a liquid therein and is adapted to releasably secure a filter. The filter is arranged for communication with a lower reservoir, which lower reservoir receives liquid that has passed through the filter. The lower reservoir may be adapted to comprise means for dispensing the filtered liquid to a user or to other reservoirs wherein the filtered liquid may be heated or cooled by means of heating or cooling elements or infused with a CO₂ to create an effervescent liquid.

It is therefore an object of the present invention to provide a filter unit for liquids that is relatively inexpensive and compact in size, such that it may filter liquid fed into a first reservoir.

It is another object of this invention to provide a beverage cooler unit that provides a cooling mechanism having size and power consumption advantages over conventional cooling devices.

It is yet another object of this invention to provide a water filter and cooler unit that filters tap water prior to dispensing.

It is yet another object of the invention to provide a beverage dispenser unit that is artistic in design.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic cross-sectional view of the beverage dispenser according to the present invention;

FIG. 2 is an exploded view of the beverage dispenser according to the present invention;

FIG. 3 is an illustration of the beverage dispenser of the present invention comprising a filter;

FIG. 4 is an illustration of the beverage dispenser of- the present invention comprising a filter and cooling device;

FIG. 5 is an illustration of the beverage dispenser of the present invention comprising a filter, a cooling device and a non-cooled reservoir;

FIG. 6 is an illustration of the beverage dispenser of the present invention comprising a cooling device and a heating device;

FIG. 7 is a schematic diagram of the power supply circuit of the present invention;

FIG. 8 is a schematic diagram of an alternative power supply circuit of the present invention; and,

FIG. 9 is an illustration of the beverage dispenser of the present invention comprising a CO₂ charging unit.

### DETAILED DESCRIPTION OF THE INVENTION

It should be appreciated at the outset that, in the detailed description that follows, like reference numbers on different drawing views are intended to identify identical, or functionally similar, structural elements of the invention in the respective views. Additionally, it should be appreciated that the particular embodiments disclosed herein are presented solely for purposes of illustration and are not intended to limit the scope of the present disclosure and claims. It should be further appreciated that the phrase “essentially similar” as used herein relative to the various embodiments of the present invention is intended to refer to the fact that the various embodiments may comprise similar structural elements, including but not limited to: filter assemblies, spigots, lids, reservoirs, etc.

The present invention generally comprises a beverage dispenser for filtering and dispensing water or other beverages. The invention may be adapted to include, alone or in combination, a filter assembly, a cooling unit for providing cooled beverages, a heating unit for providing heated beverages, a CO₂ charging unit for providing effervescent beverages or may be adapted to dispense filtered water at ambient room temperature. The filtering, cooling, heating and CO₂ charging units may be conveniently provided in a self-contained, compact, portable canister and the beverage dispenser may also be configured for providing beverages at ambient temperature. The beverage dispenser includes a removable filter unit such that common tap water may be purified, e.g., to meet NSF International standards. The invention may also be used to provide other chilled or heated beverages, such as lemonade, tea or flavored drinks, on demand.

The beverage dispenser of the present invention may be configured to comprise an upper non-cooled reservoir, a connecting or collecting reservoir, one or more fluid control assemblies (e.g., check valves), one or more filters, a lower chilled reservoir, a lower heated reservoir, a lower CO₂ reservoir, one or more dispensing valves (e.g., spigots), and an outer housing and lid.

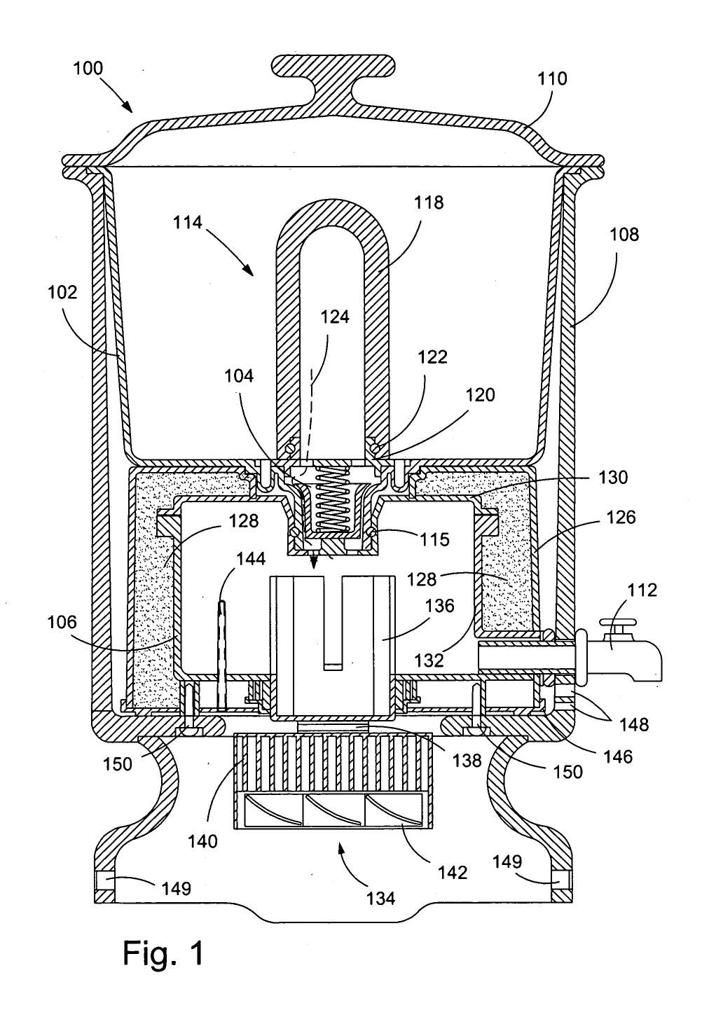

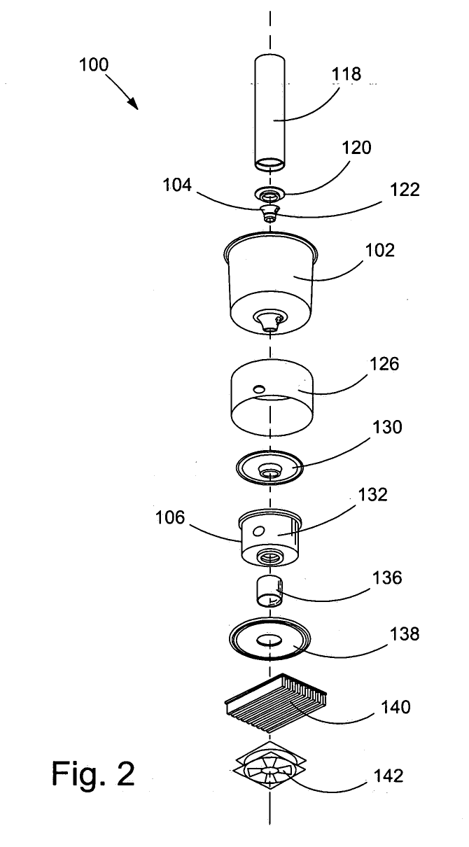

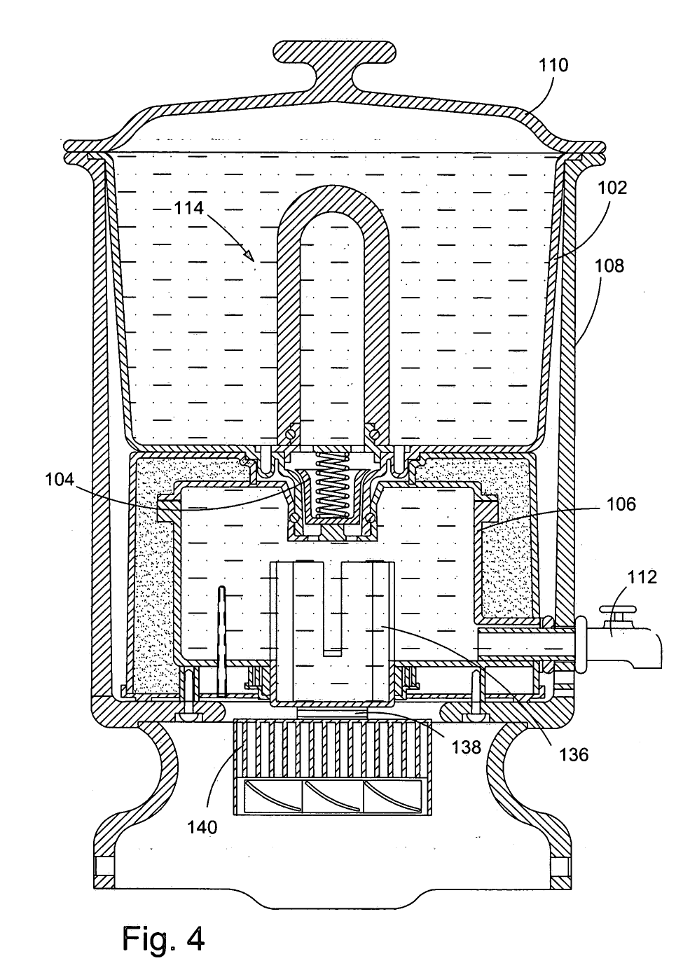

Referring now to the Figures, FIGS. 1, 2 and 4 illustrate a beverage dispenser 100 according to the present invention operatively arranged for dispensing chilled beverages. In these figures it is seen that beverage dispenser 100 broadly comprises upper non-chilled reservoir 102, check valve 104, lower chilled reservoir 106, outer housing 108, lid 110, and spigot 112.

Upper non-chilled reservoir 102 is designed to contain a quantity of liquid, such as water, substantially at room temperature. Upper non-chilled reservoir 102 is typically cylindrical in shape and constructed from molded plastic or stainless steel depending on the liquid to be filtered and chilled. Upper non-chilled reservoir 102 is formed to provide a large cylindrical opening bordered by a lip structure at the top for input of liquid and a relatively narrow cylindrical opening at the bottom for output of liquid through check valve 104 into chilled reservoir 106. Non-chilled reservoir 102 further includes a filter assembly 114, and a gasket 115. It should be appreciated by those having ordinary skill in the art that while a substantially cylindrically shaped beverage dispenser, and associated components are disclosed herein, other shapes of beverage dispenser and dispenser components are contemplated

Filter assembly 114 further includes filter 118, filter base 120, and sealing gasket 122. Filter 118 is typically a removable purification filter unit, such as a composite ceramic/carbon filter, that ensures water, e.g., common tap water, is substantially purified and meets NSF standards. Filter 118 may be commercially obtained from Fairey Industrial Ceramics, Ltd. of England under the tradename DOULTON-IMPERIAL 6″ STERASYL ATC CANDLE. When filter 118 is “spent”, water does not flow through the filter, indicating it is time to replace the filter with a new one. Filter 118 is adapted for fit with filter base 120. Gasket 122 creates a seal between filter base 120 and non-chilled reservoir 102 when the filter is screwed into check valve 104 to form filter assembly 114. Gasket 122 provides a tight seal between filter base 120 and filter 118. Filter assembly 114 may be secured to non-chilled reservoir 102 by turning threaded stud filter base 120 into non-chilled reservoir 102. This attachment mechanism provides easy installation and removal of filter assembly 114. Gasket 115 positioned on the neck of non-chilled reservoir 102 provides a leak-proof seal when non-chilled reservoir 102 is joined to chilled reservoir 106. Alternatively, the beverage dispenser of the present invention could be adapted for accommodating other types-of filters; for example, the beverage dispenser could be adopted to accommodate one or more BRITA® or P\overline{U}R® type filters. Additionally, while the filter assembly of the present invention is illustrated as being disposed and releasably secured between upper non-chilled reservoir and lower chilled reservoir, the filter assembly of the present invention may be disposed and secured between upper non-chilled reservoir and a connecting or collecting reservoir as described infra.

Check valve 104 is inserted in a recessed portion of the base of non-chilled reservoir 102. Check valve 104 is any conventional check valve or other conventional fluid control assembly. Check valve 104 joins non-chilled reservoir 102 in fluid communication with chilled reservoir 106. When check valve 104 is contacted by filter assembly 114, liquid contained in non-chilled reservoir 102 flows through check valve 104 into chilled reservoir 106 along path 124. Non-chilled reservoir 102 and filter assembly 114 are easily removable for cleaning by simply lifting non-chilled reservoir 102 out of the outer housing 108. It should be appreciated by those having skill in the art that the present invention may be adapted to comprise more than one filter assembly and more than one corresponding check valves. For example, two, or a plurality of filter assemblies and their associated check valves and components could be disposed in linear relationship with one another or, operatively arranged about a common radius for passing liquid from the upper non-chilled reservoir to the lower chilled reservoir.

Lower chilled reservoir 106 is designed to receive a quantity of substantially room temperature liquid from upper non-chilled reservoir 102 and efficiently chill the liquid to a desired drinking temperature. Lower chilled reservoir 106 includes an outer wall 126, insulator 128, reservoir top 130, inner wall 132, and chilling/heating assembly 134.

Outer wall 126, reservoir top 130, and inner wall 132 are typically cylindrical in shape and may be formed from injected molded ABS plastic. Outer wall 126 is formed to provide a planar top structure with a relatively narrow opening, which functions to physically support non-chilled reservoir 102 and an open bottom structure. Reservoir top 130 is molded to define a relatively narrow cylindrical opening for insertion of non-chilled reservoir 102. Inner wall 132 is formed to provide a cylindrical opening for insertion of chilling/heating probe 136 and attachment of chilling/heating assembly 134.

Reservoir top 130 is attached to inner wall 132 by screws, which fasten reservoir top 130 to lip of inner wall 132 to provide an enclosed cavity for liquid. Inner wall 132 with attached reservoir top 130 is inserted in outer wall 126. The cavity formed between outer wall 126 and inner wall 132 is substantially filled with insulator 128, typically thermal expansion polyurethane foam. Insulator 128 provides insulating value to chilled reservoir 106.

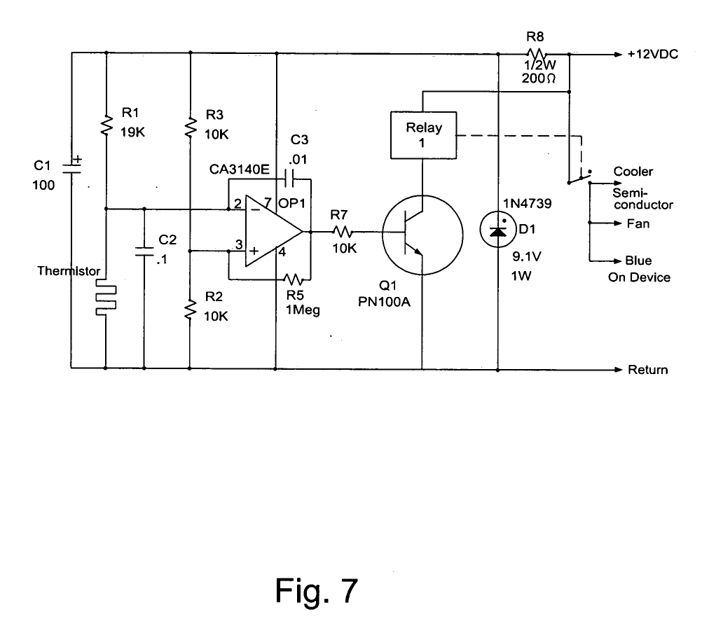

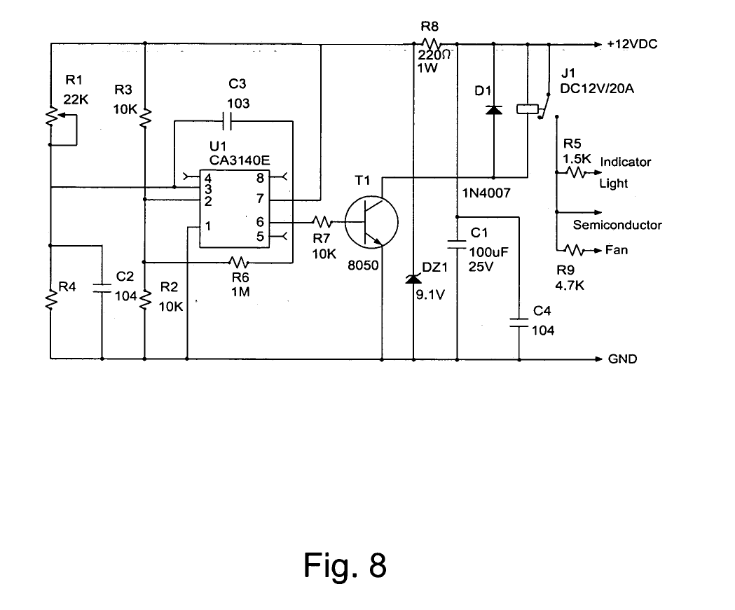

Chilling/heating assembly 134 provides chilling capacity of chilled reservoir 106. Chilling/heating assembly 134 includes chilling/heating probe 136, semi-conductor disk 138, heat exchanger 140, fan 142, thermal switch 144, and chiller tank-mounting base 146 and other electronically controlled devices. As shown in FIGS. 7 and 8, the various electrical components of the present invention may be supplied with electrical power and controlled by circuits generally known in the art.

Chilling/heating probe 136 is provided for cooling liquid in lower chilled reservoir. While a semi-conductor chilling mechanism (Peltier element) is described herein, other chilling units may be utilized for chilling liquid in lower reservoir, for example, a mini-compressor may be used to chill liquid in lower reservoir. The semi-conducting chilling mechanism comprises extruded anodized aluminum for providing increased surface area for enhanced chilling capacity. Chilling/heating probe 136 is inserted in chilled reservoir 106 through a cylindrical opening in inner wall 132.

The cooling capacity of chilling/heating probe 136 is provided by semi-conductor disk 138 made from two ceramic substrate plates used to sandwich positive and negative semiconductor pellets of doped bismuth telluride. The semi-conductor disk is placed between chilling/heating probe 136 and heat exchanger 140; heat exchanger 140 is screwed to chiller tank-mounting base 146. Semiconductor disk 138 is typically a conventional square thermal disk with a cooling side in physical contact with chilling/heating probe 136 and a heat transfer side in physical contact with heat exchanger 140. Semiconductor disk 138 is of a type generally known in the art of electronic cooling and may be commercially obtained from TE Technology, Inc. of Traverse City, Mich. When an electrical current is applied to the semiconductor disk, the semiconductor disk exhibits the Peltier Effect and extracts thermal energy at the cold side, effectively extracting heat from the liquid contained in chilled reservoir 106 via chilling/heating probe 136 and transferring the extracted heat via the hot side to heat exchanger 140. Chilling/heating assembly 134 may operate on any voltage ranging from 9 to 24 volts DC and 110 to 240 volts AC.

Heat exchanger 140 is any conventional heat sink, such as an extruded aluminum heat sink. At its maximum output, heat exchanger 140 measures approximately 96° F. Heat exchanger 140, which is typically larger in diameter than semiconductor disk 138, is attached to the bottom of chiller tank-mounting base 146 by screws and secures semiconductor disk 138 to lower chilled reservoir 106 in contact with chilling/heating probe 136.

The heat transferred from semiconductor disk 138 to heat exchanger 140 is dissipated to the external environment by fan 142 through heat sink ventilation holes 148 in outer housing 108. Fan 142 is attached to heat exchanger 140 by screws on the outer fins of the heat exchanger 140.

Chilling/heating assembly 134 is attached to lower chilled reservoir 106 by two screws located at the base of heat exchanger 140 that fastened directly into the base of the chiller tank-mounting base 146. Typically, the liquid volume capacity of lower chilled reservoir 106 is 40 ounces, a volume approximately three and one-half times smaller than the capacity of upper non-chilled reservoir 102. The smaller volume capacity of lower chilled reservoir 106 provides rapid chilling of liquid following dispensing. Typically, when lower chilled reservoir 106 is emptied and refilled with liquid from upper non-chilled reservoir 102, the chilling time is approximately 4 to 6 minutes.

The temperature of the liquid in lower chilled reservoir 106 is monitored and regulated by thermal switch 144 that measures the temperature of the liquid and turns the system on when the temperature of the liquid goes above 42 degrees Fahrenheit and shuts the system off when the liquid fall below 38 degrees Fahrenheit. This temperature range can be changed by changing the thermal switch value or by utilizing an adjustable thermal switch.

Upper non-chilled reservoir 102, check valve 104, and lower chilled reservoir 106 are encased in outer housing 108. Outer housing 108 is comprised of an insulated resin shell, typically formed from polyurethane that is readily molded into different artistic and decorative forms. Outer housing 108 further includes a plurality of heat sink intake ventilation holes 148 and a pair of exhaust ventilation holes 149. Ventilation holes 148 allow the intake of air to cool heat exchanger 140 and ventilation holes 149 function to dissipate heat generated by lower chilled reservoir 106. Outer housing 108 is attached to lower chilled reservoir 106 by screws 150. Outer housing 108 provides an insulating value to help keep the liquid inside beverage dispenser 100 cool to reduce the time required to chill the liquid.

Spigot 112 extends from housing 108 through cylindrical openings in outer wall 126 and inner wall 132 into the bottom of lower chilled reservoir 106. Spigot 112 provides easy access to the chilled liquid. Spigot 112 is typically any conventional spigot, such as a THOMPSON™ spigot used on typical bottle water coolers.

Liquid contained in upper non-chilled reservoir 102 is protected from airborne contaminates, such as dust and particulates, by lid 110, which is typically dome-shaped and provides a handle for ease of placing or removing lid 110 from its resting position on outer housing 108.

Beverage dispenser 100 is a self-contained, compact, portable device that provides chilled liquid on demand. In one example, beverage dispenser 100 (11″ diameter×17¾″ high) readily fits on a counter top. The compact size and portability of beverage dispenser 100 are ideally suited to a number of environments, such as use in homes, offices, camps, boats and recreational vehicles (RVs).

In operation, a consumer fills non-chilled reservoir 102 with a liquid, such as tap water. Gravity feeds tap water through filter 118 via check valve 104 into lower chilled reservoir 106. Chilling/heating assembly 134 chills liquid in lower chilled reservoir 106. The consumer dispenses the chilled liquid from spigot 112. The withdrawn liquid volume is replenished by liquid from upper non-chilled reservoir 102, which is rapidly cooled to the desired drinking temperature.

In an alternative embodiment of the present invention, removing filter 118 allows a liquid in upper non-chilled reservoir 102 to flow directly thru check valve 104 into lower chilled reservoir 106 to allow other chilled beverages, such as lemonade, tea or KOOL-AID® brand beverage, which do not require purification, to be dispensed on demand.

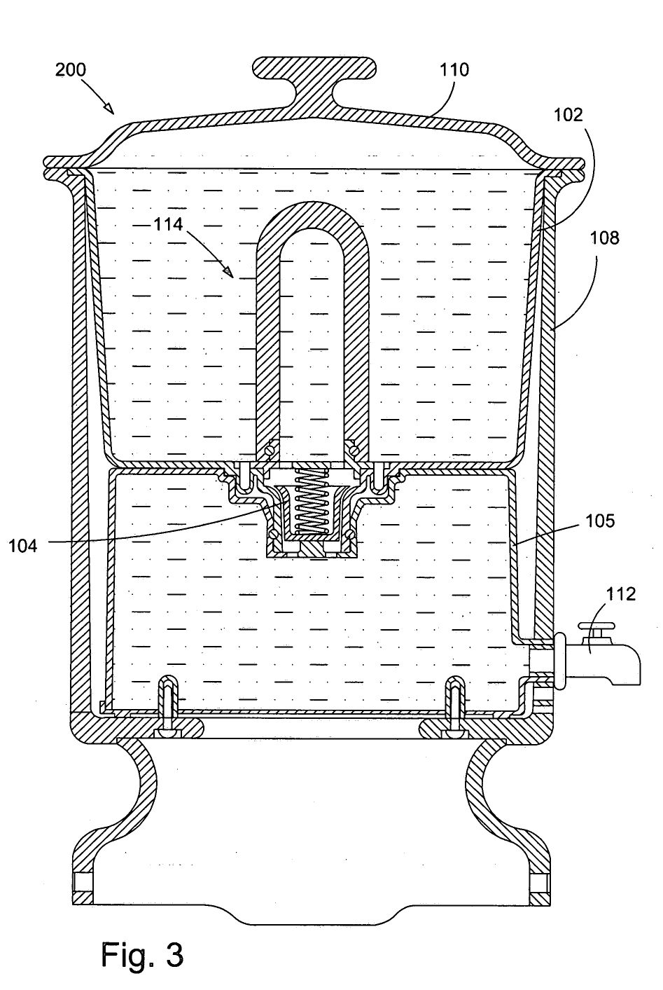

Referring now to FIGS. 3, 5-6 and 9, the present invention may also be adapted for maintaining a beverage at ambient air temperature, for heating and cooling beverages, or for infusing beverages with CO₂ gas.

FIG. 3 illustrates beverage dispenser 200, which is essentially similar to beverage dispenser 100, but configured for dispensing beverages at or near ambient air temperature. Hence, beverage dispenser 200 is shown to comprise upper non-chilled reservoir 102, which is separated from lower non-chilled reservoir 105 by means of filter assembly 114.

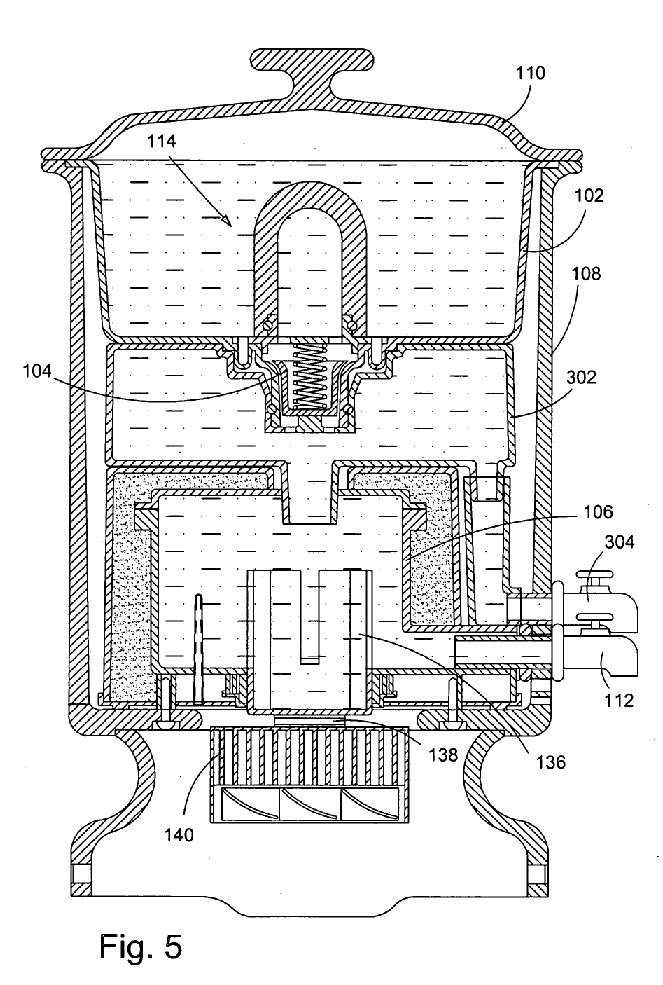

Alternatively, FIG. 5 illustrates that the present invention may be configured to comprise beverage dispenser 300, which is also essentially similar to beverage dispenser 100, but which is configured for dispensing cooled beverages and beverages maintained at ambient air temperatures. In this embodiment, it is seen that beverage dispenser 300 comprises non-chilled connecting reservoir 302, which is disposed between upper non-chilled reservoir 102 and lower chilled reservoir 106. Because the rate of flow of highly efficient filters tends to be slow, non-chilled connecting reservoir 302 is provided to increase the rate at which the lower reservoirs (heated, cooled or ambient air temperature reservoirs) may be filled when liquids are dispensed. Filter assembly 114 is provided for passing liquid from upper non-chilled reservoir 102 to non-chilled connecting reservoir 302. Non-chilled connecting reservoir 302 is operatively arranged to pass filtered liquid, which liquid is maintained at ambient air temperature, to spigot 304 or to lower chilled reservoir 106, which is adapted to chill beverages by means of a semi-conducting cooling element or other appropriate cooling means, for example, a mini-compressor. Chilled beverages may be dispensed by means of spigot 112. It should be appreciated, however, that while the various embodiments disclosed herein are shown as comprising one or more individual spigots for dispensing various beverages (heated, cooled, ambient, and CO₂ infused as described infra) the present invention may be configured to comprise a single spigot and associated valve and switching mechanisms (mechanical or electromechanical) for dispensing the various beverages on demand.

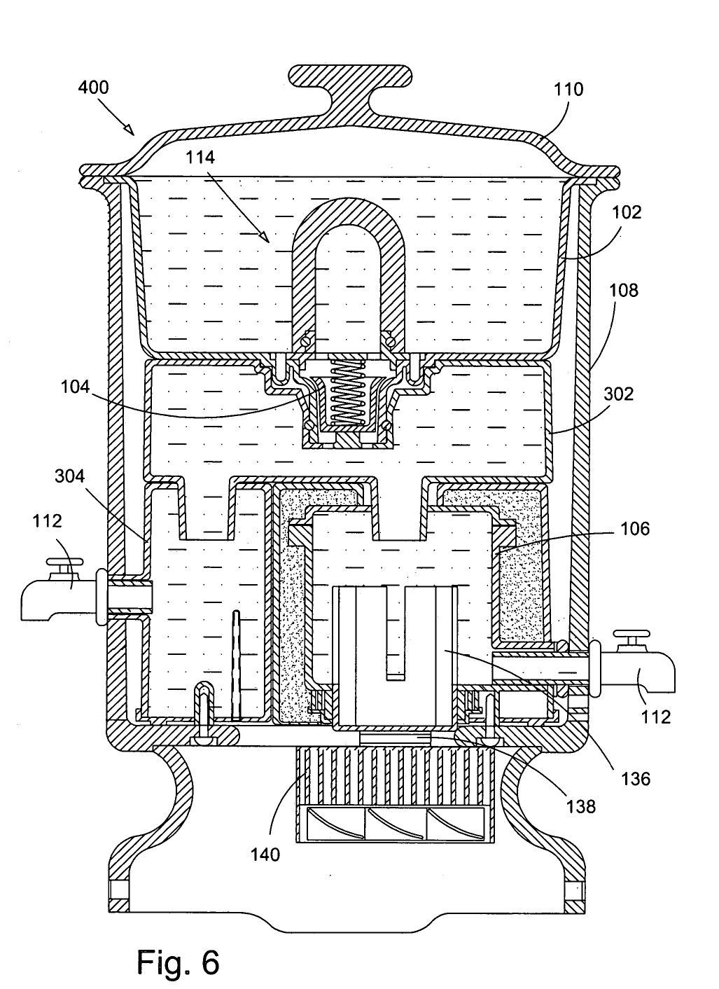

In FIG. 6 it is seen that the beverage dispenser of the present invention may be configured for dispensing beverages that are chilled or heated. In this embodiment beverage dispenser 400 is configured to comprise upper non-chilled reservoir 102, non-chilled connecting reservoir 302, lower chilled reservoir 106 and lower heated reservoir 304. Filter assembly 114 is configured to pass liquid from upper non-chilled reservoir 102 into non-chilled connecting reservoir 302. Non-chilled connecting reservoir 302 is operatively arranged to pass filtered liquid, which liquid is maintained at ambient air temperature, to lower chilled reservoir 106 and to lower heated reservoir 304. Lower chilled reservoir 106 may be chilled by means of a semi-conducting cooling element or other appropriate cooling means, e.g., a mini-compressor, and lower heated reservoir 304 may be heated by a semi-conducting element, heating coil, or by means of heat emanating from heat exchanger 140. Beverage dispenser 400 may also be adapted to dispense beverages at ambient air temperature if desired. It should be appreciated that check valves 104, or other appropriate means may be disposed between the connecting reservoir and the lower reservoirs to prevent mixing of the heated and cooled liquids. The lower heated and chilled reservoirs may be insulated from one another by means of appropriate insulative materials.

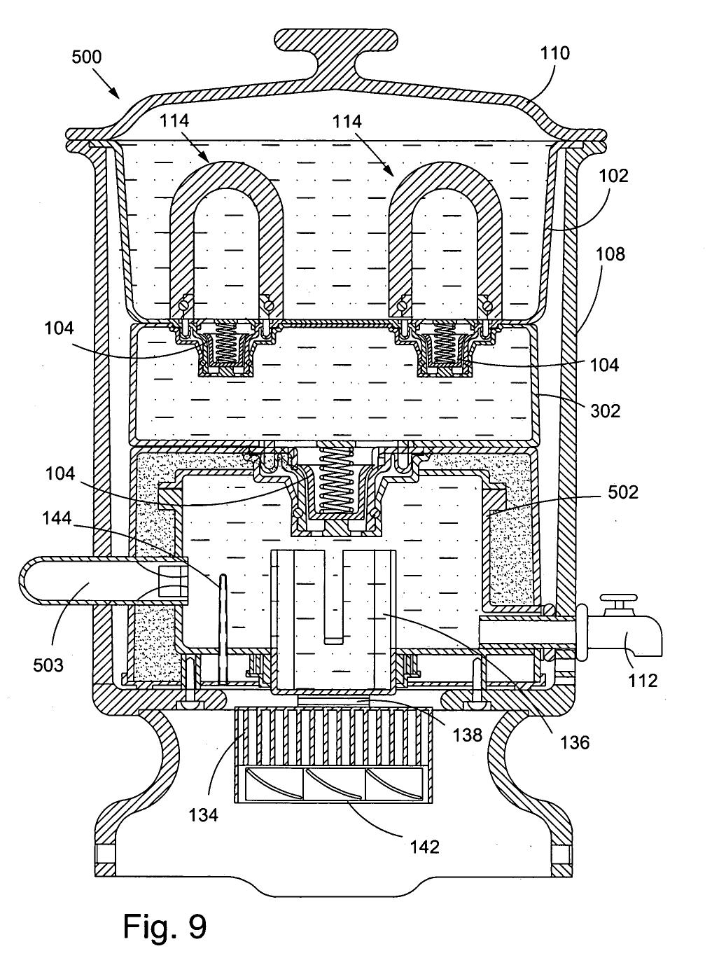

Finally, FIG. 9 illustrates that one or more embodiments of the present invention may be configured to comprise a CO₂ charging unit for infusing a liquid with CO₂ such that effervescent beverages may be dispensed. In this figure, it is seen that beverage dispenser 500 comprises upper non-chilled reservoir 102, non-chilled connecting reservoir 302, lower CO₂ reservoir 502, and CO₂ cartridge 503. CO₂ cartridge 503 may be similar to that typically utilized for soda and tonic water dispensers and may be rotatably secured and sealed to the CO₂ reservoir. To prevent beverages infused with CO₂ and contained within the CO₂ reservoir from becoming “flat”, CO₂ reservoir comprises a check valve for preventing CO₂ gas from passing to the connecting reservoir. This embodiment further illustrates that the beverage dispenser of the present invention may be configured to comprise more than one releasable filter assembly. It should be appreciated that beverage dispenser 500 may also be further adapted to dispense non-carbonated beverages, and/or beverages that are heated and cooled. Such beverages may be dispensed via individual spigots associated with each type beverage to be dispensed or all of the beverages may be dispensed on demand by means of a single spigot and associated valve and switching mechanisms (mechanical or electromechanical (not shown)).

Thus, it is seen that the objects of the present invention are efficiently obtained, although modifications and changes to the invention should be readily apparent to those having ordinary skill in the art, which modifications are intended to be within the spirit and scope of the invention as claimed.

What is claimed is:

1. A beverage dispenser comprising:
at least one upper reservoir for holding a liquid beverage;
at least one lower reservoir for receiving said liquid beverage from said at least one upper reservoir;
at least one filter element operatively arranged to be removably disposed between said at least one upper and said at least one lower reservoir;
at least one heating/cooling element disposed in said at least one lower reservoir and operatively arranged to heat/cool said liquid in said lower reservoir; and,
means for dispensing said liquid beverage from said at least one lower reservoir.

2. The beverage dispenser of claim 1 comprising a connecting reservoir disposed between said at least one upper reservoir and said at least one lower reservoir.

3. The beverage dispenser of claim 2 wherein said filter element is disposed between said at least one upper reservoir and said connecting reservoir.

4. The beverage dispenser of claim 1 wherein said at least one heating/cooling element comprises a semi-conducting heating/cooling element.

5. The beverage dispenser of claim 4 wherein said at least one heating/cooling element is operatively arranged to cool said liquid in said at least one lower reservoir.

6. The beverage dispenser of claim 4 wherein said at least one heating/cooling element is operatively arranged to heat said liquid in said at least one lower reservoir.

7. The beverage dispenser of claim 4 comprising a variable thermostat for setting, monitoring, and maintaining the temperature of said liquid beverage in said at least one lower reservoir.

8. A beverage dispenser comprising:
an upper reservoir for holding a liquid beverage;
at least one lower reservoir for receiving said liquid beverage from said upper reservoir;
at least one filter element operatively arranged to be removably disposed between said upper reservoir and said at least one lower reservoir;
at least one semi-conducting heating/cooling element disposed in said at least one lower reservoir and operatively arranged to heat/cool said liquid in said at least one lower reservoir; and,
at least one means for dispensing said liquid beverage from said at least one lower reservoir.

9. The beverage dispenser of claim 8 comprising a connecting reservoir disposed between said at least one upper reservoir and said at least one lower reservoir.

10. The beverage dispenser of claim 9 wherein said filter assembly is disposed between said at least one upper reservoir and said connecting reservoir.

11. The beverage dispenser of claim 10 wherein said semi-conducting heating/cooling element is operatively arranged to cool said liquid beverage.

12. The beverage dispenser of claim 10 wherein said semi-conducting heating/cooling element operatively arranged to heat said liquid beverage.

13. The beverage dispenser of claim 11 comprising a second semi-conducting heating/cooling element disposed in a second lower reservoir and operatively arranged to heat said liquid beverage therein.

14. The beverage dispenser of claim 13 operatively arranged to dispense cooled, warmed, and ambient temperature liquids.

15. The beverage dispenser of claim 14 operatively arranged to infuse a gas into said liquid beverage.

16. The beverage dispenser of claim 8 wherein said upper reservoir is manually filled with said liquid beverage.

17. The beverage dispenser of claim I wherein said upper reservoir is manually filled with said liquid beverage.

18. A beverage dispenser comprising:
an upper reservoir for holding a liquid beverage, said upper reservoir operatively arranged to be manually filled with liquid;
at least one lower reservoir for receiving said liquid beverage from said upper reservoir;
at least one releasable filter assembly disposed between said upper and lower reservoirs; and, at least one spigot means for dispensing said liquid beverage from said lower reservoir.

19. The beverage dispenser of claim 18 further comprising a semi-conducting heating/cooling element disposed in said at least one lower reservoir.

20. The beverage dispenser of claim 18 further comprising means for infusing said liquid beverage in said lower reservoir with a gas.
